(19) United States
(12) Patent Application Publication
(10) Pub. No.: US 2006/0062719 A1
(43) Pub. Date: Mar. 23, 2006

(54) Process for preparing so2f2 and so2clf

(75) Inventors: Veronique Mathieu, Wavre (BE); Alain Lambert, Beauvechain (BE)

Correspondence Address: CONNOLLY BOVE LODGE & HUTZ, LLP, P O BOX 2207, WILMINGTON, DE, 19899, US

(73) Assignee: SOLVAY S.A., Brussels (BE)

(21) Appl. No.: 10/525,426

(22) PCT Filed: Aug. 21, 2003
(86) PCT No.: PCT/EP03/09474

§ 371 Date: Feb. 23, 2005

(30) Foreign Application Priority Data
Aug. 23, 2002 (FR) 02/10596

(51) Int. Cl. C01B 17/45

(52) U.S. Cl. 423/468

(57) ABSTRACT

Process for preparing SO₂F₂ according to which SO₂ClF is introduced into a gas-phase reaction step with hydrogen fluoride.

The present invention relates to a process for preparing sulphuryl fluoride (SO₂F₂) and to an integrated process for preparing SO₂F₂ and SO₂ClF.

SO₂F₂ can be used as a fumigant, in particular as a substitute for methyl bromide. SO₂ClF may be used as a reagent, especially for producing sweeteners.

U.S. Pat. No. 3,320,030 relates to the preparation of SO₂F₂ and SO₂ClF by reaction of SO₂, chlorine and hydrogen fluoride over a catalyst comprising active carbon and an alkali metal bifluoride. This process does not allow SO₂F₂ to be produced with satisfactory productivity. In particular, the rapid deactivation of the catalyst makes it difficult to exploit this process industrially under economically acceptable conditions. Moreover, the ratio between SO₂F₂ and SO₂ClF is subject to substantial fluctuations over time, which is undesirable when the aim is to co-produce the two products industrially.

The objective of the invention is to overcome these problems.

The invention accordingly provides a process for preparing SO₂F₂ which comprises introducing into a gas-phase reaction step SO₂F₂ precursors comprising at least SO₂ClF and hydrogen fluoride.

It is understood that the term “introducing SO₂F₂ precursors including at least SO₂ClF” necessitates the introduction in the gas-phase reaction step of pre-existing SO₂ClF, which is different from the process described in U.S. Pat. No. 3,320,030, in which the only SO₂ClF which could react with hydrogen fluoride to produce SO₂F₂ would have been formed in situ.

By SO₂F₂ precursors are meant compounds capable of forming SO₂F₂ by reacting with hydrogen fluoride, such as, in particular SO₂ClF, SO₂Cl₂ or a mixture—preferably equimolar—comprising SO₂ and Cl₂. In the process according to the invention the SO₂ClF content of the SO₂F₂ precursors is generally at least 80 mol %. Frequently this content is greater than or equal to 90 mol %. Preferably it is greater than or equal to 95 mol %. With particular preference it is greater than or equal to 99 mol %. A precursor consisting essentially of SO₂ClF is especially preferred.

The reaction is often carried out in the presence of a catalyst. This catalyst frequently comprises a microporous material. The catalyst is preferably based on active carbon. In that case the BET specific surface area of the catalyst is generally greater than or equal to 700 m²/g, preferably greater than or equal to 900 m²/g. The BET specific surface area of the catalyst is generally less than or equal to 3000 m²/g, preferably less than or equal, to 2000 m²/g. Specific examples of active carbons which can be used are those sold under the respective names NORIT® RB3 and CARBOTECH® AG2-4.

In the process according to the invention the reaction is generally carried out at a temperature greater than or equal to 150° C. The temperature is preferably greater than or equal to 175° C. With particular preference the temperature is greater than or equal to 200° C. In the process according to the invention the reaction is generally carried out at a temperature less than or equal to 300° C. The temperature is preferably less than or equal to 275° C. With particular preference the temperature is less than or equal to 250° C.

In the process according to the invention the reaction is generally carried out at a pressure greater than or equal to 1 bar. The pressure is preferably greater than or equal to 2 bar. In the process according to the invention the reaction is generally carried out at a pressure less than or equal to 10 bar. The pressure is preferably less than or equal to 5 bar.

In the process according to the invention the molar ratio between hydrogen fluoride and the sum of SO₂F₂ precursors introduced in the gas-phase step is generally greater than or equal to 1. Frequently this ratio is greater than or equal to 2. This ratio is preferably greater than or equal to approximately 3. In the process according to the invention the molar ratio between hydrogen fluoride and the sum of SO₂F₂ precursors introduced in the gas-phase step is generally less than or equal to 10. Frequently this ratio is less than or equal to 5. This ratio is preferably less than or equal to approximately 4.

It has been found that, when the process according to the invention is implemented in the presence of a catalyst as described earlier on, it is possible to adjust the contact time and the flow rates of the reactants so as to obtain very high conversions of SO₂F₂ precursors, in particular of SO₂ClF, while maintaining a high SO₂F₂ productivity and good catalyst stability. A typical conversion rate is greater than or equal to 95%. The conversion rate is preferably greater than or equal to 99%. The process according to the invention allows a conversion rate of 100% to be achieved.

In one preferred embodiment of the process according to the invention the reaction is carried out in the substantial absence of chlorine. By substantial absence of chlorine is meant a level of molecular chlorine in the reaction mixture of less than or equal to 10% by weight. A level of chlorine in the reaction mixture of less than or equal to 1% by weight is more particularly preferred. A level of chlorine in the reaction mixture of less than or equal to 1000 ppm by weight is even more particularly preferred. In one version, the reaction mixture is completely devoid of chlorine.

In a second preferred embodiment of the process according to the invention the SO₂F₂ precursors and hydrogen fluoride introduced into the gas-phase step are substantially devoid of hydrogen chloride. By substantially devoid of hydrogen chloride is meant a level of hydrogen chloride in the SO₂F₂ precursors or hydrogen fluoride of less than or equal to 10% by weight. A hydrogen chloride content of less than or equal to 1% by weight is more particularly preferred. A hydrogen chloride content of less than or equal to 1000 ppm by weight is even more particularly preferred.

The two preferred embodiments of the process according to the invention which have been described hereinabove allow the deactivation of catalysts based on active carbon to be prevented with particular efficacy. A combination of these two preferred embodiments of the process according to the invention is especially preferred.

In another aspect, invention provides an integrated process for preparing SO₂F₂ and optionally SO₂ClF comprising

(a)—a first step in which hydrogen fluoride is reacted with SO₂ and chlorine and/or with SO₂Cl₂ to give SO₂ClF;

(b)—a second step in which at least some of the SO₂ClF obtained in step (a) is reacted with hydrogen fluoride, preferably by the process according to the invention described earlier on.

Step (a) is carried out preferably in the gas phase, preferably in the presence of a catalyst based on active carbon as described earlier on.

Step (a) is generally carried out at a temperature less than or equal to 150° C. The temperature is preferably less than or equal to 130° C. With very particular preference the temperature is less than or equal to 120° C. Step (a) is generally carried out at a temperature greater than or equal to 50° C. The temperature is preferably greater than or equal to 80° C. With very particular preference the temperature is greater than or equal to 100° C. With even more particular preference the temperature is greater than or equal to 105° C.

It has been found that, within the especially preferred temperature range, it is possible to obtain SO₂ClF without coproduction of SO₂F₂, with a high yield and high selectivity.

Step (a) is generally carried out at a pressure as described earlier on for the process for preparing SO₂F₂ according to the invention.

It has been found that, when step (a) is implemented in the presence of a catalyst as described earlier on, it is possible to adjust the contact time and the flow rates of the reactants so as to achieve SO₂ClF precursor conversions which correspond to those described earlier on in the context of the conversions of SO₂F₂ precursors and that similar advantages are obtained.

By SO₂ClF precursors are meant compounds capable of forming SO₂ClF by reacting with hydrogen fluoride, such as, in particular SO₂Cl₂4 or a mixture—preferably equimolar—comprising SO₂ and Cl₂.

In the integrated process for preparing SO₂F₂ and optionally SO₂ClF according to the invention, the molar ratio between the hydrogen fluoride and the sum of SO₂ClF precursors introduced in step (a) is generally greater than or equal to 1. Frequently this ratio is greater than or equal to 1.05. This ratio is preferably greater than or equal to approximately 1.1. In the process according to the invention, the molar ratio between the hydrogen fluoride and the sum of SO₂ClF precursors introduced in step (a) is generally less than or equal to 3. Frequently this ratio is less than or equal to 2. This ratio is preferably less than or equal to approximately 1.5.

Step (b) is preferably the process according to the invention described earlier on. However, other ways of converting SO₂ClF to SO₂F₂ may be envisaged, such as, for example, dismutation of SO₂ClF in the gas phase over a catalyst based on active carbon as described earlier on.

In one version of the integrated process for preparing SO₂F₂ and optionally SO₂ClF the reaction mixture obtained from step (a) is subjected to a separating operation such as, for example, a distillation whose purpose is to concentrate the SO₂ClF and to reduce the amount of HCl therein prior to its introduction into step (b). Where appropriate this separation is carried out advantageously so as to provide SO₂ClF substantially devoid of hydrogen chloride, as described earlier on.

Where appropriate molecular chlorine present may also be separated off, by distillation for example.

In one particular aspect the separation is carried out so as to recover a fraction including SO₂ClF, which is intended for introduction into step (b), and, on the other hand, at least one fraction consisting essentially of SO₂ClF. This latter fraction may be removed from the process and used for other purposes, optionally after a finishing treatment.

The invention likewise provides the process for obtaining SO₂ClF in accordance with step (a), starting from SO₂Cl₂ or SO₂ and chlorine, by reaction with hydrogen fluoride, as described hereinabove.

The examples below are intended to illustrate the invention, though without limiting it.

### EXAMPLE 1

### SO₂ClF+HF→SO₂F₂

The reaction was carried out in a tubular metal reactor 1.3 cm in diameter and 30 cm in length which was placed in an oven. 25 ml of catalyst (Norit® RB3 active carbon) were introduced into the reactor and flushed under helium at a test temperature for 0.5 h.

HF was then introduced for 30 to 60 min. After this period the reactants were fed in at flow rates adjusted in accordance with the desired contact time under a pressure of 3 bar.

The reaction products obtained over time were analysed by online gas chromatography.

An SO₀F₂ precursor consisting essentially of SO₂ClF was introduced, along with HF, in a HF/SO₂ClF molar ratio of 3. The two reactants were substantially devoid of molecular chlorine and of hydrogen chloride. The temperature of the reaction was 225° C. The contact time was 11 s. The conversion rate of SO₂ClF was 100%. An SO₂F₂ productivity of 1.4 kg per kg of catalyst per h was observed. Production was carried out for 280 h without deactivation of the catalyst.

### EXAMPLE 2

### SO₂+Cl₂ Mixture (1 mol: 1 mol)+HF→SO₂ClF

The reaction was carried out in the same way as in Example 1 but under the following conditions and with the following results:

An equimolar mixture of SO₂ and Cl₂ was introduced along with HF in an HF/(SO₂+Cl₂) molar ratio of 1.1. The temperature of the reaction was 110° C. The contact time was 30 s. The conversion rate of SO₂+Cl₂ was 100%. An SO₂ClF productivity of 0.9 kg per kg of catalyst per h was observed. Production was carried out for more than 390 h without deactivation of the catalyst.

### EXAMPLE 3 (COMPARATIVE)

### SO₂+Cl₂ Mixture (1 mol: 1 mol)+HF→SO₂F₂

The reaction was carried out in the same way as in Example 2 but under the following conditions and with the following results:

The HF/SO₂+Cl₂) molar ratio was 9.5. The temperature of the reaction was 250° C. The contact time was 30 s. The conversion rate of SO₂+Cl₂ was 100%. An SO₂F₂ productivity of 0.05 kg per kg of catalyst per h was observed. After 5 h substantial deactivation of the catalyst was observed.

At equal precursor conversion rates, the process according to the invention allows improved productivity in terms of SO₂F₂ while preventing rapid deactivation of the catalyst.

1. Process for preparing SO₂F₂, which comprises introducing in a gas-phase reaction step SO₂F₂ precursors comprising at least SO₂ClF and hydrogen fluoride.

2. Process according to claim 1, in which the level of SO₂ClF is at least 80 mol % of the sum of SO₂F₂ precursors introduced into the reaction step.

3. Process according to claim 2, in which the level of SO₂ClF is at least 95 mol % of the sum of SO₂F₂ precursors introduced into the reaction step.

4. Process according to claim 1, in which the reaction is carried out in the presence of a catalyst based on active carbon.

5. Process according to claim 1, in which the reaction is carried out at a temperature of 150 to 300° C. and at a pressure of 1 to 10 bar.

6. Process according to claim 1, in which the reaction is carried out in the substantial absence of chlorine.

7. Process according to claim 1, in which the SO₂F₂ precursors and the hydrogen fluoride introduced in the gas-phase step are essentially devoid of hydrogen chloride.

8. Integrated process for preparing SO₂F₂ and optionally SO₂ClF, comprising
(a) a first step in which hydrogen fluoride is reacted with SO₂ and chlorine and/or with SO₂Cl₂ to give SO₂ClF;
(b) a second step in which at least some of the SO₂ClF obtained in step (a) is reacted with hydrogen fluoride by the process of claim 1.

9. Process according to claim 8, in which step (a) is carried out in the gas phase in the presence of a catalyst based on active carbon at a temperature less than or equal to 150° C.

10. Process according to claim 8, in which step (a) is carried out at a temperature greater than or equal to 100° C. and not exceeding 120° C.

11. Process according to claim 8, in which, prior to step (b), the reaction mixture obtained from step (a) is subjected to a separating operation intended to concentrate the SO₂ClF and to reduce its HCl content.

12. Process according to claim 11, in which the separation is carried out so as to recover, on the one hand, a fraction comprising SO₂ClF, which is intended for introduction into step (b), and, on the other hand, at least one fraction consisting essentially of SO₂ClF.

13. Process according to claim 3, in which the reaction is carried out in the presence of a catalyst based on active carbon.

14. Process according to claim 4, in which the reaction is carried out at a temperature of 150 to 300° C. and at a pressure of 1 to 10 bar.

15. Process according to claim 14, in which the reaction is carried out in the substantial absence of chlorine.

16. Process according to claim 15, in which the SO₂F₂ precursors and the hydrogen fluoride introduced in the gas-phase step are essentially devoid of hydrogen chloride.

17. Process according to claim 9, in which step (a) is carried out at a temperature greater than or equal to 100° C. and not exceeding 120° C.

18. Process according to claim 17, in which, prior to step (b), the reaction mixture obtained from step (a) is subjected to a separating operation intended to concentrate the SO₂ClF and to reduce its HCl content.

19. Process according to claim 18, in which the separation is carried out so as to recover, on the one hand, a fraction comprising SO₂ClF, which is intended for introduction into step (b), and, on the other hand, at least one fraction consisting essentially of SO₂ClF.
